(19) United States
(12) Patent Application Publication
(10) Pub. No.: US 2004/0214555 A1
(43) Pub. Date: Oct. 28, 2004

(54) Automatic control of simultaneous multimodality and controlled multimodality on thin wireless devices

(76) Inventors: Sunil Kumar, San Diego, CA (US); Subramanya Ravi, San Diego, CA (US); Chandra Kholia, San Diego, CA (US); Dipanshu Sharma, San Diego, CA (US)

Correspondence Address: FISH & RICHARDSON, PC, 12390 EL CAMINO REAL, SAN DIEGO, CA, 92130-2081, US

(21) Appl. No.: 10/787,842

(22) Filed: Feb. 25, 2004

Related U.S. Application Data
(60) Provisional application No. 60/451,044, filed on Feb. 26, 2003.

(51) Int. Cl. H04L 12/66

(52) U.S. Cl. 455/414.1; 455/403

(57) ABSTRACT

A system for controlling of multiple kinds of modality in wireless telephones. A client controls modality on telephones which do not support simultaneous modality. This is done by suspending a browser when a voice command is detecting, storing the state of the browser, and then automatically restarting the browser when necessary. Another aspect operates in a simultaneous modality system and sends a context sensitive vocabulary to a voice server. This enables improved performance from multimodality, and also minimizes the amount of latency.

### CROSS-REFERENCE TO RELATED APPLICATIONS

This application claims priority to U.S. Provisional Patent Application No. 60/451,044, filed Feb. 26, 2003.

This application is related to co-pending U.S. patent application Ser. No. 10/040,525, filed Dec. 28, 2001, and to co-pending U.S. patent application Ser. No. 10/336,218, filed Jan. 3, 2003, which claims priority to U.S. Provisional Patent Application Serial No. 60/348,579, filed Jan. 14, 2002, and to co-pending U.S. Provisional patent application Ser. No. 10/349,345, filed Jan. 22, 2003, which claims priority to U.S. Provisional Patent Application Serial No. 60/350,923, filed Jan. 22, 2002, each of which is incorporated herein by reference in its entirety.

### BACKGROUND

Multimodality refers to the ability to access information in any of a number of different forms. In the context of a wireless telephone, for example, multimodality may allow the user to access wireless information via speech, via VoiceXML, or via text, e.g. a WAP browser. Information can be sent as text or spoken words (speech) and can be received in synthesized speech, video, text, animation or the like.

The capability of the device and network determines the capability of multimodality, and the ways that changes between the different modes are supported. Specifically, the inventor has recognized that delays and/or errors may be caused by attempting to request multimodal content on a device and/or network that is not fully capable of running voice and data sessions simultaneously. The inventor has also recognized that even when complete simultaneous multimodality is possible, certain techniques can be used to improve the response time and speed of the operation.

In some devices, such as certain mobile phones, the user must switch sessions in order to experience multimodality. Other devices and networks are capable of running simultaneous voice and data sessions. Devices such as pocket pc, desktop and some of the upcoming 3G devices fall into this category. Running multiple modes at the same time is often referred to as “simultaneous multimodality”.

Devices that are not capable of simultaneous voice and data are typically only capable of “sequential modality”, where the user switches modes between voice and data sessions. The installed based of mobile devices with browser-only capabilities may make it desirable to accommodate sequential modality. Moreover, sequential modality may be quite successful in simple applications such as Driving Directions, Email, and Directory Assistance etc. However, it is less convincing for applications such as Airline Reservations, Entertainment etc.

### SUMMARY

The present disclosure describes techniques that allow use of Controlled/Simultaneous Multimodality on thin wireless devices such as mobile phones to support sequential multimodality and/or simultaneous multimodality.

In an aspect, techniques are disclosed where a currently running application on a client is automatically suspended by the client, and its state saved, and the mode is then automatically changed.

Another aspect describes techniques for increasing network speed in a simultaneous multimodality system.

### BRIEF DESCRIPTION OF THE DRAWINGS

FIG. 1 shows a basic block diagram of the carrier architecture, showing the thin-client(s) or clients, the gateway, and the content portals.

FIG. 2 shows a flowchart of voice recognition;

FIG. 3 shows the telephone client and the responsive software layers;

FIG. 4 shows a flowchart of the multimedia client and its interaction with the gateway controller;

FIGS. 5 and 6 shows a way of requesting information using controlled multimodality;

FIG. 7 shows a flowchart using simultaneous multimodality for minimizing latency time; and

FIG. 8A-8D show screen shots of the multimodality system.

### DETAILED DESCRIPTION

Multimodal technology allows users to listen to, or view, their content during the same browsing session. Multimodality is characterized by different forms of communication. Two most typical modes include voice and data. Different types of Multimodality can be defined based on the way the bandwidth interface is shared between the modes.

Existing deployed Multimodal technology on class B or higher wireless devices such as Mobile phones allows users to use a browser based application, such as a wireless or WAP browsers on the mobile phone to view content that is in VisualXML or some flavor thereof, such as WML or xHTML, or to hear and/or say content via a voice server (e.g., VoiceXML compliant or otherwise) and listen to the content. Users may have the capability to view or listen, but not both.

Sequential multimodality preferably avoids multiplexing of the voice and data channels; and rather carries out an explicit switch to shift between two modes. Typically this solution is used in 2G networks and handsets which have minimal resident intelligence that can be downloaded onto the handset to enhance the process. A common such device may be a mobile phone with a WAP browser. Such devices form the mass of wireless users; it is estimated, for example, that over 1 billion of such devices may exist. However, these browser-only mobile phones have a few limiting factors that may be impediments to multimodality. Typically no software can be installed on these phones. Moreover, the WAP browser cannot be used for accessing wireless data and placing a voice call at the same time. Disconnecting the data browser and then starting a voice call or vice-versa introduces latency, the amount of which is dependent on the network. The inventor has found that disconnecting the data browser and then starting a voice call or vice-versa introduces latency dependent on the network.

A voice channel is typically used to make a call to a voice/speech server to provide/receive the voice input/output. Once this process is completed, the handset waits for an asynchronous event from the server, providing the result.

Simultaneous Multimodality, on the other hand, is for Thin Clients and 3G networks, PDA devices, and/or Desktops and the like. It uses Session Initiation Protocol, or “SIP” as the voice signaling method or other VoIP methods. It does not require switching, because the voice and data channel are active simultaneously. This scenario provides greater control and better response time for the same application.

An embodiment describes Controlled Multimodality which can be used for thin intelligent clients on 2/2.5/3G networks. The application can reside locally on the phone, thus reducing the latency involved in fetching the application from the server. A data session can be automatically suspended when a voice session starts, based on actions taken by the client running on the phone. The data session is resumed, not initiated again, once the voice session has ended. This feature may reduce the time required to restart the data session. Previous systems have used a browser only client where the server sends a message to the mobile phone in order to start the data session and other systems have required the user to manually start the data session by starting the browser.

Alternately, the data sessions can be closed responsive to network access, to reduce the usage of air-time minutes. This would require re-establishment of network connections when again required. The latencies involved may therefore be offset by the reduced usage of air-time minutes.

The applications disclosed in this embodiment use the processing capabilities of the handsets to facilitate the switchover. This control provides strategic advantages such as better response time, lesser computational dependence on the server. Further, the clients which are capable of such capability can control the channels of communication with the server by requesting or closing communication connections to the server, thus gaining greater control over the process.

The present application describes a special multimode client (MM Client SDK) running on the mobile phone. The client may affect a special controlled multimodality by providing a client-initiated switch between voice and data mode.

The client software operates to carry out certain communication with the server that was earlier done by the browser. The client also controls presenting the data on the mobile screen. Thus this solution may bypass the internal browser and use phone API (e.g. JAVA/BREW) to present information on the phone.

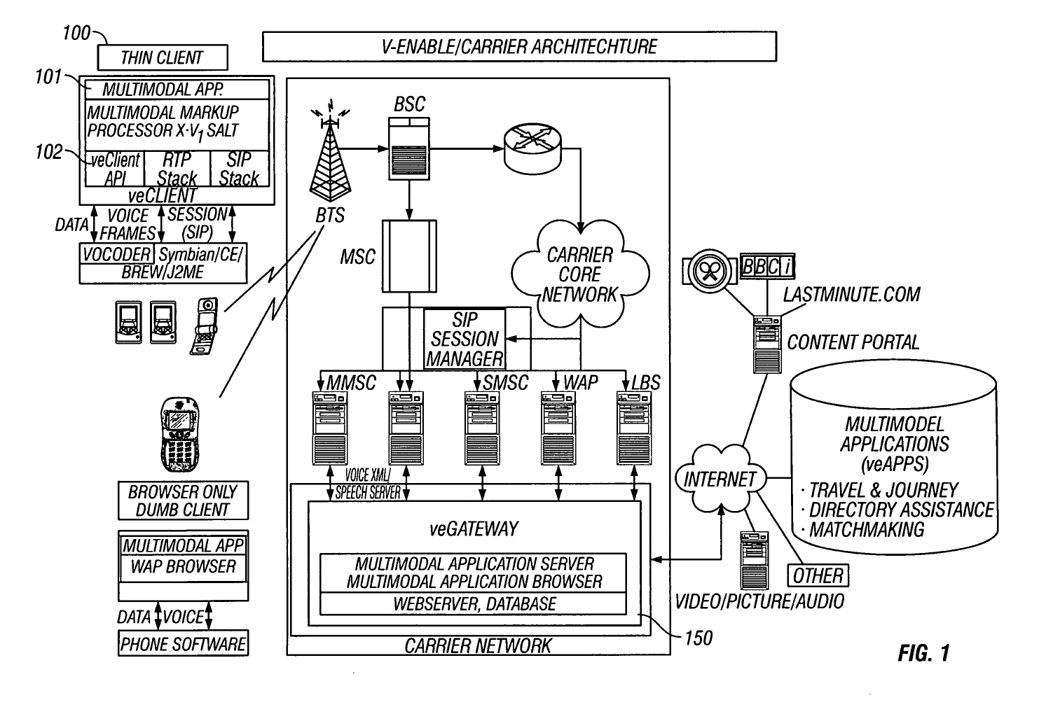

A MultiMode gateway controller (MMGC) allows mobile devices to communicate with different gateways and provides a platform to develop/execute Multimodal applications. FIG. 1 shows the high level architecture of a MMGC. V-Enable's MultiMode gateway controller 150 is described in V-Enable's copending applications, and it enables wireless handset users to interact with content via a combination of visuals/voice/keypad/touch-screen etc. The MultiMode Platform may be software based and does not require specific integration with the Wireless Operator's infrastructure. The Multimode Client allows Multimodal client applications to communicate with a MultiMode gateway controller such as shown in FIG. 1. The MMGC and the client application communicate using a protocol/sequence of events and APIs defined and exported by MM Client SDK.

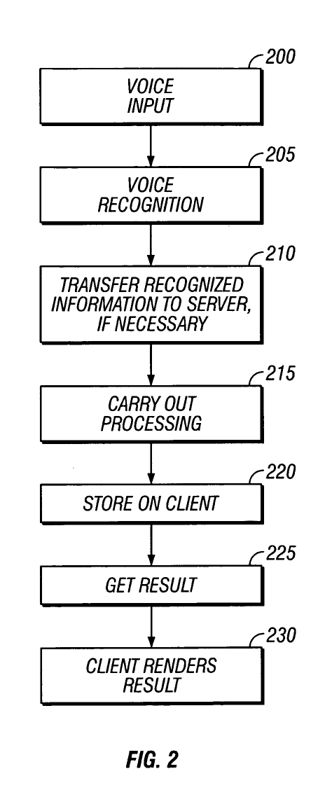

A typical multi-modal application has a sequence of events, which can be summarized as follows and as shown in the flowchart of FIG. 2:

First, voice input is received from the client at 200. Next, input voice recognition is carried out either at the client or server at 205. If recognition is done at the client, then the recognized input is transferred to the server at 210. Server side processing is carried out based on the recognized input at 215. The result is stored on the server in a pre-defined format such that it is accessible by the client at 220. Data connection by the client to obtain the result of the request based on a pre-defined protocol occurs at 225, and then the client renders the result in the requested mode at 230.

In a “browser-only” client, a user dials into a voice/speech server, which has the ability to recognize the user input. A grammar is specified at the server side, to recognize the user speech input. At this stage, the user needs to disconnect the voice channel connection and wait for communication from the server regarding the result of the request. After completion of the server side processing, the recognized result is pushed back to the user.

As described above, this system takes advantage of the software-running capability of certain such as using BREW or J2ME with capabilities such as Networking and TAPI. The present system teaches use of Multimodal applications using Networking and TAPI functionalities of a phone-installed software development kit.

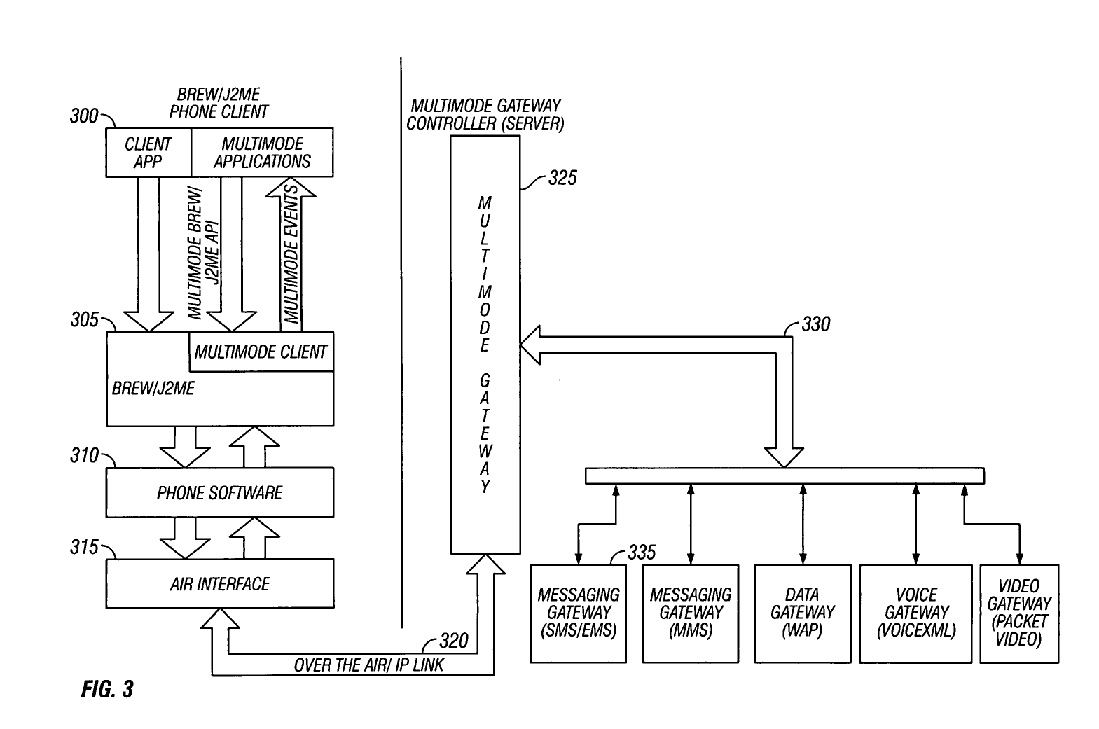

FIG. 3 depicts the MM Client in the thin client protocol stack, including the client application and the multimodal application. These are shown operating through a BREW interface 305 which interfaces with the phone software 310. The phone software 310 controls the communication layer 315 which creates an over the air IP link 320 with a multimodal gateway 325. The multimodal gateway 325 communicates via channel 330 with a number of messaging and data gateways such as 335.

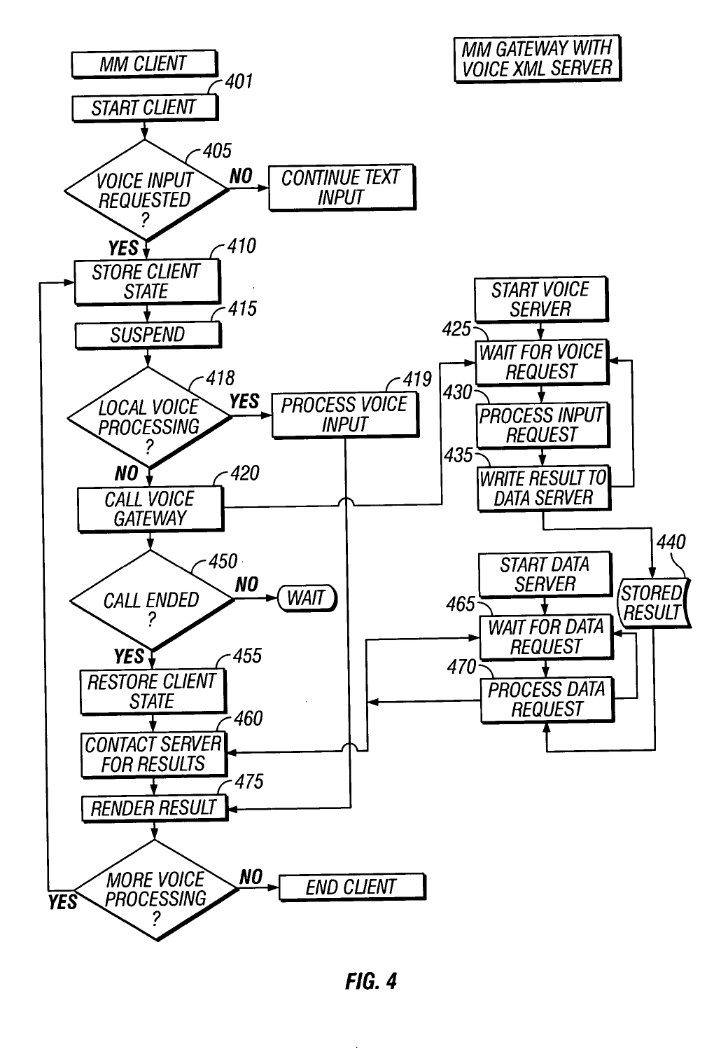

The communication with this device proceeds according to the flowchart of FIG. 4. At 401, the client application is started. This is typically started in data mode. The user requests, at 405, that the client request the multimodal client to start a voice session with a voice gateway. This can be done, for example, by pushing a button on the screen in the data/visual XML mode. The application cannot be kept active while making a telephone call. Accordingly, the state of the application is stored at 410, and the application is suspended at 415. The application checks to see if the voice processing will be local at 418, and if so processes it at 419. If not, a voice session is established with a voice gateway such as 150, at 420. This voice gateway has the capability to understand user speech input. The configuration of this operation is configured and controlled by the multimodal client.

At 425, the user speaks, thereby providing a voice input to the system. The user's voice is identified at 430 via speech server. The server may include a grammar set that is specific to identify user input. User input is recognized at 435, and the result is sent to a data server to generate the data. The result is then stored on the server in a predefined format at 440, as an object which is later retrieved by the multimedia client. The voice call then ends. Once the call has ended, the application receives a resume within based on the underlying platform at 450. This causes the client application to resume based on the stored State at 455.

The client then starts a network connection at 460 to obtain a result. In the embodiment, the request is passed to the server as parameters of a URL. The handset shifts its mode of operation from voice to data in order to retrieve those results. The request is sent at 465. A script in the server identifies the parameters of the URL at 470 and provides the results based on the requested parameters. The script may be a Java servlet or other type script. The multimedia client receives the recognition results at 475, and passes them to the application. The application continues the results for its specific operations and can initiate the voice session again as needed.

One important feature is that of reducing the latency in the network. Table 1, which is reproduced below, is based on latencies from various carrier networks such as Sprint, Verizon, AT&T, Nextel, T-Mobile, Vodafone, orange, STAT, NTT Docomo, and others. As shown in the table, a client controlled switch with controlled multimodality may allow a 50% decrease in voice to data switching time. The data to voice switching time has also been reduced by 20%, based on software increases.

[image]

In an embodiment, the software operates on the BREW execution platform residing on the wireless handset. An example will be given herein using this multimodal platform to enable driving instructions. An important feature of this system is its ability to synchronize between the application and the gateway. In the given example, a BREW based application initiates a voice session using the multimodal client from a BREW enabled phone. The voice XML application processes the results based on user speech input and stores it on the server. The server storage is done in a format which the rule-based multimedia client can understand. The multimedia client uses a protocol as described above, in order to obtain the results of the user input.

As above, present-day BREW enabled phones do not have the capability to keep a client application active while making a voice call. Accordingly, the state of the application is initially stored, followed by the application execution being suspended when a phone call is made. Conversely, once the application resumes from its suspended state via a resume command, the application is restored to its last state and execution is continued.

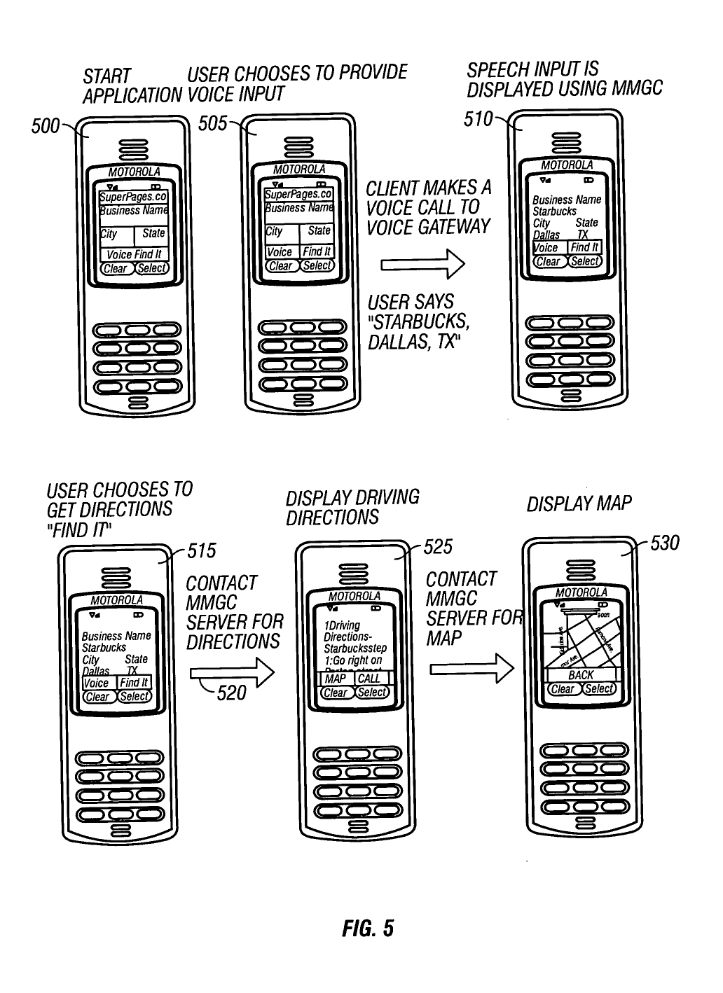

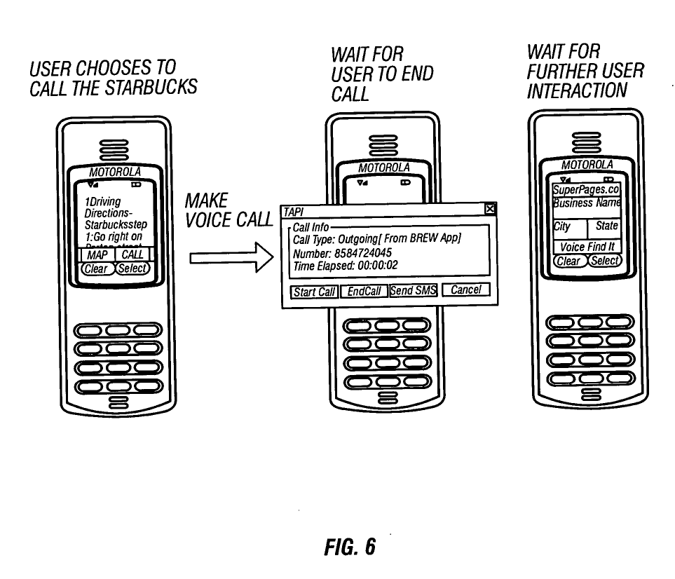

In the example, assume that a user needs to get to a location, for example a particular business destination and does not know how to get there. At 500 in FIG. 5, the user starts the application and chooses to provide voice input at 505. The choice to provide voice input causes the user to call a voice server which recognizes the voice input based on a predefined grammar. For example, this may recognize the business name, city and state of interest here Starbucks, Dallas Tex.

The server side process, upon receiving the recognized information, begins a database search in order to find the location, require driving directions and map of the location. The client probes the server for the results, and displays them at 510 when available. As noted above, the request uses a voice channel to request the information, but the result in the form of non-voice data is returned. This causes the client to shift back to the visual XML display.

510 shows the client display's downloaded result. The client also includes special-purpose buttons including a “find it” button to get driving directions, and a map. Once this is obtained, data connections are used to obtain the relevant information from the multimedia server corresponding to the user choice. 525 shows displaying the driving directions, and 530 shows displaying a map. The telephone number for the business may also be downloaded and display, causing the client to shift from data mode to voice mode in order to make a call it selected. After finishing the call, the system returns to its initial screening waiting further input.

Another embodiment describes Simultaneous Multimodality. This may be used on thin intelligent clients on 2/2.5/3G networks. The application can reside locally on the phone, thus reducing the latency involved in fetching the application from the server. A data session can be used and both voice and data are multiplexed on the same data channel for a true simultaneous multimodal experience. The voice is encoded in QCELP/AMR/GSM format and is transported as packets to the multimedia gateway controller (MMGC) for speech recognition. The MMGC controls the session and synchronizes the data and voice traffic.

In an embodiment, both the data session and the voice session are always on. The user can press a key at any time to signal the beginning of providing either voice or text. The output can also be in voice or text form, depending on the nature of the application.

Previous systems started the voice session using features available within the browser or using BREW/J2ME/Symbian TAPI calls as described above. The present embodiment enables initiating a voice session using this software, allowing a VoIP connection to be established using SIP protocol.

FIG. 1 shows the MM Client application 101 in the thin client protocol stack 102. The MMGC 150 and the client application 101 communicate using a protocol/sequence of events and APIs defined and exported by the software environment of the MM Client.

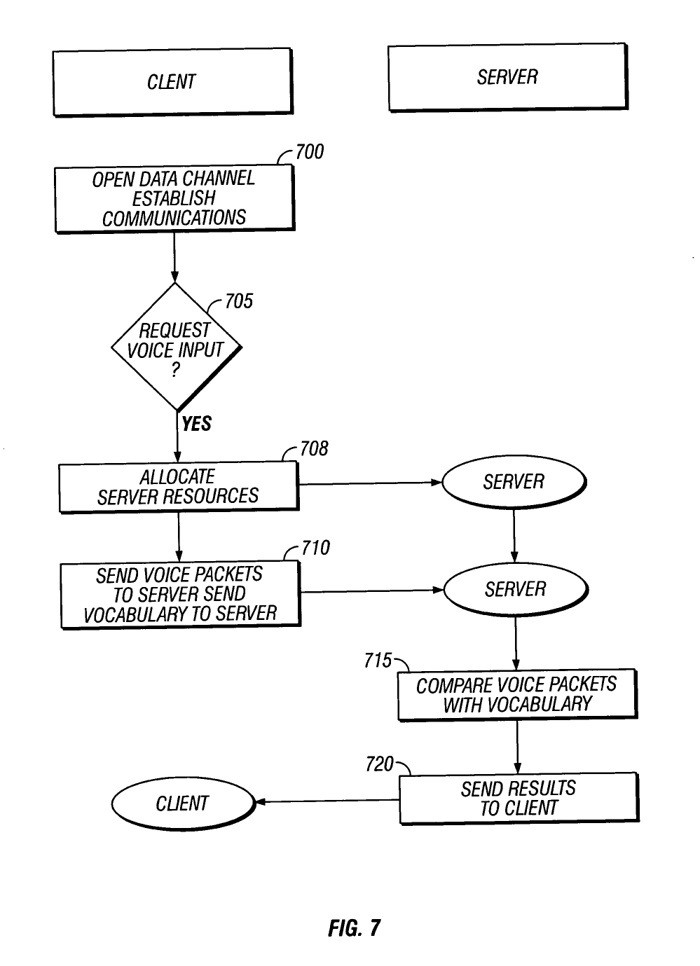

When executing a multimodal application, the client carries out the flowchart of FIG. 7, described herein.

At 700, the client opens the data channel and establishes the session with the MMGC server. The user navigates through the application in default mode, which can be, for example, data mode. Every input box, or wherever the speech is enabled, has an attached indicia, and an associated speech grammar used for speech recognition.

At 705, the user presses a “key” to provide the voice input, and the user starts speaking input. This causes the client to send the speech in the form of encoded packets to the MMGC server 150. First, at 708, the server allocates appropriate speech resources needed for speech recognition.

At 710, voice packets and vocabulary information are sent to the server. Preferably, the vocabulary information may be context sensitive—that is, the vocabulary sent is based on the possible options that are being presented to the user. The vocabulary can be predefined by the client and can be kept at the MGGC server or elsewhere and then selected based on the environment.

The speech recognition engine will typically accept the ULAW codec format. The client however supports QCLEP/EVRC/GSM/AMR formats on various devices. A set of codec converters may also be used which may convert any of the QCELP/EVRC/GSM/AMR codec format into ULAW format for speech recognition.

The voice packets are compared against the vocabulary provided by the client at 715.

The speech recognition component performs the recognition and sends the results to the MMGC server. The result could be a set of elements (multiple matches) or no result in case of failure. The MMGC server then passes the results back to the client at 720. The MMGC can also pass the TTS (text to speech) output to the client depending on the application.

While the voice packets are sent over to MMGC, the data channel is active (voice is sent over data channel) and the user can be allowed to perform any other activity during this voice recognition period, depending on the nature of the application.

The client receiving the results would either display the result or prompt the user to repeat the input or take some operation as needed by the application.

The client can then decide to clear the voice session to free the resources at the MMGC server. Depending on the application, the client may alternatively initiate the voice session again.

An embodiment describing use of the MMGC server to enable Multimodal Directory Assistance Service using Simultaneous Multimodality follows. In this embodiment, the user is trying to locate a business listing in a particular city/state. This example is similar to a 411 service which provides listing information to their customers.

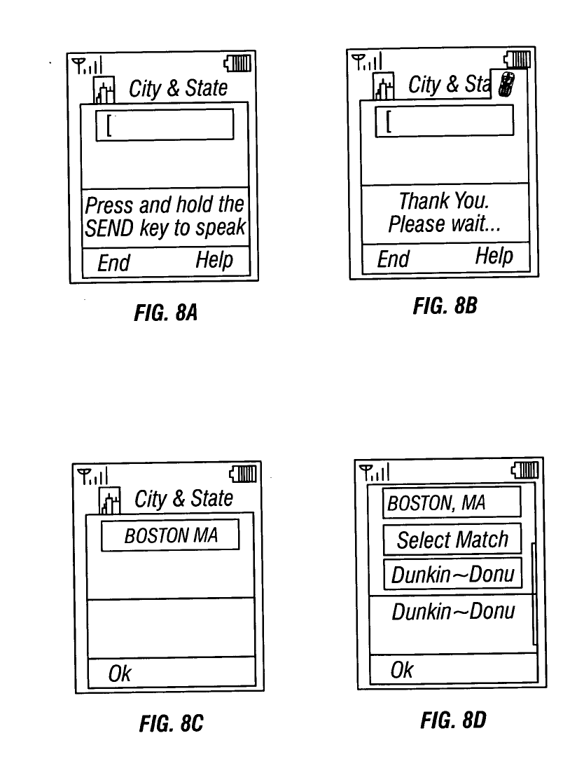

FIG. 8A shows the initial screen. The screen has a text input box available for providing city input. The user can also speak the word “city” at this moment, by pressing a predefined key on the screen to enable speech input.

Each screen where the user can provide speech input is identified by the use of a visual message and an audio prompt from the MMGC server. Initially, only a connection is established with the MMGC server and no speech resources are allocated to the client. At this point user has the option to either use text mode or voice mode. If user decides to use the voice mode, the user can press the send key (predefined) and speak the input (say Boston Mass.). The speech resources are allocated for this application using a signaling protocol (SIP) as explained with reference to FIG. 7, and spoken audio is encoded (QCELP) and sent in form of packets to the MMGC server.

FIG. 8B shows the user having spoken the input and voice packets are being transferred to MMGC server. In order to speaking an input, the user presses and HOLDs the SEND key, and speaks the input while keeping the key pressed. The key is released upon completion.

The application displays a wait message while it gets the reply from the server. The MMGC server is busy processing the voice packets and comparing with the grammar attached with the input. In this particular case the grammar is a set of all cities in United States.

For example, assume that the user says Boston, Mass. as audio input. The MMGC server identifies the audio input and sends back the result in form of text to the client. The client displays the result and waits for the user confirmation. In this case, the confirmation will be as shown in FIG. 8C.

The user selects the city and moves to the next screen which prompts the user to provide the name of the desired listing. Again, the user has both text and voice mode available. The grammar for this input box may be a list of all the listings in Boston city. The grammar information is passed to the MMGC server using a preexisting protocol such as SIP. The MMGC appropriately loads the appropriate listing grammar needed for speech recognition. If the user decides to use the voice mode, the user can press the send key (predefined) and speak the input (say Dunkin Donuts). The speech resources are allocated for this application using a signaling protocol (SIP) and spoken audio is encoded (QCELP) and sent in form of packets to the MMGC server. The MMGC server identifies the audio input and sends back the result in form of text to the client.

This time the MMGC sends multiple matches to input “Dunkin Donuts”. The client displays the results and waits for the user confirmation as displayed in FIG. 8D. The user navigates through all the Dunkin Donuts in Boston area and chooses one as the desired Dunkin Donuts. Once the user selects the appropriate Dunkin Donuts, the details of the listing is displayed on the screen.

Although only a few embodiments have been disclosed in detail above, other modifications are possible, and this disclosure is intended to cover all such modifications, and most particularly, any modification which might be considered predictable. For example, the above has used BREW as the software layer, but the concepts may be used with any client software development kit, including Java, Symbian, Windows stinger, or others. Moreover, while the above has described applications for mapping, it should be understood that similar techniques can be used for other multimedia operations, which control the mode of phone operation depending on the location within the process. In addition, while the above has described the thin-client as being a telephone, it should be understood that any thin-client with wireless capability or wired capability can be used for this purpose.

All such modifications are intended to be encompassed within the following claims, in which:

What is claimed is:

1. A method, comprising:
operating a browser based application in a first client;
detecting a request for operations on another application, which is other than said browser based application on said first client;
automatically storing a state of said browser based application on said first client, responsive to said detecting; and
after storing said state, processing a request in said other application.

2. A method as in claim 1, where said another application is a voice based application.

3. A method as in claim 2, wherein a said request is a request which is processed locally.

4. A method as in claim 2, wherein said request is sent to a server which processes results of said request.

5. A method as in claim 2, wherein said processing a request comprises processing a voice request, and writing a result of the voice request to a data server.

6. A method as in claim 5, further comprising, after processing said request in said other application, restoring the browser based application based on said state.

7. A method as in claim 6, further comprising, after restoring the browser based application, requesting data from the data server responsive to said voice request.

8. A method as in claim 5, wherein said first client is a mobile telephone, operating over a wireless telephone system.

9. A method as in claim 8, wherein said wireless telephone system is one which only supports sequential multimodality.

10. A method as in claim 8, wherein said wireless telephone system is one which supports simultaneous multimodality.

11. A method as in claim 8, further comprising, prior to said operations, installing an additional multimode client on said wireless telephone.

12. A method, comprising:
operating a wireless browser on a wireless telephone;
detecting a request for voice processing on said wireless telephone;
responsive to said detecting a request, automatically suspending a currently running wireless browser, based on a command from the client;
subsequent to said automatically suspending, processing a voice command using said wireless telephone.

13. A method as in claim 12, wherein said processing a voice command comprises recognizing the voice command on the wireless telephone.

14. A method as in claim 12, wherein said processing a voice command comprises sending information indicative of the voice command to a remote server.

15. A method as in claim 12, wherein said processing a voice command comprises determining data responsive to said voice command, and storing said data in the remote server.

16. A method as in claim 15, further comprising, after said storing, restarting the wireless browser in said wireless telephone.

17. A method as in claim 16, further comprising, after said restarting, using the wireless browser to obtain said data from said remote server.

18. A method as in claim 12, wherein said operating comprises operating said wireless telephone on a network that supports simultaneous multimodality.

19. A method as in claim 12, wherein said operating comprises operating said wireless telephone on a network that supports sequential multimodality. It's

20. A method, comprising:
installing a software based application on a portable telephone that communicates with a wireless network; and
using said software based application to automatically suspend a current application on said portable telephone when a specified application is requested.

21. A method as in claim 20, wherein said current application is a wireless browser, and said specified application is an application other than a wireless browser.

22. A method as in claim 21, wherein said specified application is a voice request for information from a server.

23. A method as in claim 22, wherein said software based application provides the functionality of a wireless browser in addition to the wireless browser already operating on said portable telephone.

24. A wireless telephone, comprising:
a first client, which is capable of running a browser-based application;
a user interface, associated with said first client, detecting a request for operations on another application, which is other than the browser based application;
said first client operating, responsive to detecting said request while running said browser based application, automatically suspending said browser based operation on said first client, responsive to said detecting, and after said suspending, processing a request in said other application.

25. A telephone as in claim 24, where said another application is a voice based application.

26. A telephone as in claim 24, wherein said first client stores a state of said browser, prior to said suspending.

27. A telephone as in claim 26, wherein said first client restoring the text based application based on said state after processing said request in said other application.

28. A telephone as in claim 24, wherein said wireless telephone is one which only supports sequential multimodality.

29. A telephone as in claim 24, wherein said wireless telephone is one which supports simultaneous multimodality.
